(19) United States
(12) Patent Application Publication
(10) Pub. No.: US 2016/0125808 A1
(43) Pub. Date: May 5, 2016

(54) PIXEL STRUCTURE AND DRIVING METHOD THEREOF

(71) Applicant: AU Optronics Corporation, HSIN-CHU (TW)

(72) Inventors: Wei-Chu HSU, HSIN-CHU (TW); Pi-Cheng WU, HSIN-CHU (TW); Ko-Ruey JEN, HSIN-CHU (TW); Chien-Ya LEE, HSIN-CHU (TW)

(21) Appl. No.: 14/608,415

(22) Filed: Jan. 29, 2015

(30) Foreign Application Priority Data
Oct. 31, 2014 (TW) 103137880

(51) Int. Cl. G09G 3/32

(52) U.S. Cl. CPC G09G 3/3258; G09G 3/3266; G09G 2300/0809; G09G 2310/0202; G09G 2330/028

(57) ABSTRACT

A pixel structure includes a light-emitting diode, a transistor, a data-receiving unit, a compensating unit, and a resetting unit. The transistor is configured to be electrically coupled to the light-emitting diode, and drive the light-emitting diode based on a voltage difference between the control terminal and the first terminal of the transistor. The data-receiving unit is configured to be electrically coupled to the first terminal of the transistor, and provide a pixel date signal to the first terminal of the transistor based on a first scan signal. The compensating unit is electrically coupled to the control terminal and the second terminal of the transistor to act as a current path therebetween. The resetting unit is electrically coupled to the light-emitting diode. The resetting unit is configured to respectively provide a reverse bias and reference voltage to the light-emitting diode and the control terminal of the transistor.

### RELATED APPLICATIONS

This application claims priority to Taiwan Application Serial Number 103137880, filed Oct. 31, 2014, which is herein incorporated by reference.

### BACKGROUND

1. Field of Invention

The present invention relates to display technology and a driving method. More particularly, the present invention relates to a pixel structure and a driving method.

2. Description of Related Art

With progress in technology, display technology has been continuously improving. An active-matrix organic light-emitting diode (AMOLED) display is presently one of the most important display technologies. Compared with the thin-film-transistor liquid-crystal display (TFT-LCD), display devices fabricated using AMOLED technology have a number of advantages, such as self-luminosity, wide viewing angle, high contrast, and fast response. Hence, AMOLED technology is widely applied in the displays of electronic devices.

For driving an AMOLED display, pixel structures composed of transistors are disposed in pixels, and driving transistors in the pixel structures drive an active matrix of OLED pixels based on data voltage. However, problems of transistor variability and aging of the AMOLED display result in brightness unevenness, resulting in the display quality of the display being correspondingly decreased. For solving these problems, a 7T1C (seven transistors and one capacitors) configuration is used in a conventional pixel structure for compensating for a threshold voltage of the driving transistors so as to maintain the displaying quality of the display. However, if there is a high number of transistors in the pixel structure, the aperture ratio of the pixel is correspondingly decreased.

In view of the foregoing, problems and disadvantages are associated with existing products that require further improvement. However, those skilled in the art have yet to find a solution.

### SUMMARY

The following presents a simplified summary of the disclosure in order to provide a basic understanding to the reader. This summary is not an extensive overview of the disclosure and it does not identify key/critical elements of the present invention or delineate the scope of the present invention.

One aspect of the present disclosure is directed to a pixel structure. The pixel structure includes a light-emitting diode, a transistor, a data-receiving unit, a compensating unit, and a resetting unit. The transistor includes a control terminal, a first terminal, and a second terminal. The transistor is electrically coupled to the light-emitting diode, and the transistor is configured to drive the light-emitting diode based on a voltage difference between the control terminal and the first terminal of the transistor. The data-receiving unit is electrically coupled to the first terminal of the transistor, and the data-receiving unit is configured to provide a pixel date signal to the first terminal of the transistor based on a first scan signal. The compensating unit is electrically coupled to the control terminal and the second terminal of the transistor, and the compensating unit is configured to be a current path between the control terminal and the second terminal of the transistor. The resetting unit is electrically coupled to the light-emitting diode. The resetting unit is configured to provide a reverse bias voltage to the light-emitting diode, and the resetting unit is configured to provide a reference voltage to the control terminal of the transistor.

Another aspect of the present disclosure is directed to a pixel structure. The pixel structure includes a light-emitting diode, a transistor, a data-receiving unit, a compensating unit, and a resetting unit. In addition, the transistor includes a control terminal, a first terminal and a second terminal. The transistor is electrically coupled to the light-emitting diode, and is configured to drive the light-emitting diode according to a voltage difference between the control terminal and the first terminal of the transistor. The data-receiving unit is electrically coupled to the first terminal of the transistor, and is configured to provide a pixel data signal to the first terminal of the transistor according to a first scan signal. The compensating unit is electrically coupled to the control terminal and the second terminal of the transistor, and is configured to be a current path between the control terminal and the second terminal of the transistor. The resetting unit is electrically coupled to the light-emitting diode or the second terminal of the transistor, wherein the resetting unit is configured to cause the light-emitting diode to be in a state of reverse bias, and provide a reference voltage to the control terminal of the transistor.

Still another aspect of the present disclosure is directed to a driving method. The driving method is configured to drive a pixel structure. The pixel structure comprises a light-emitting diode, a data-receiving unit, a transistor, a compensating unit and a resetting unit, and the transistor comprises a first terminal, a second terminal and a control terminal. The data-receiving unit is electrically coupled to the first terminal of the transistor, the compensating unit is electrically coupled to the second terminal and the control terminal of the transistor, and the resetting unit is electrically coupled to the light-emitting diode or the second terminal of the transistor. The driving method includes the steps of: controlling the resetting unit to receive and transmit a reference voltage to the light-emitting diode for letting the light-emitting diode in a state of reverse bias; controlling the compensating unit to provide a current path between the control terminal and the second terminal of the transistor for transmitting the reference voltage to the control terminal of the transistor; controlling the data-receiving unit to receive and transmit a pixel data signal to a first terminal of the transistor; and driving the light-emitting diode according to a voltage difference between the control terminal and the first terminal of the transistor.

In view of the foregoing, embodiments of the present disclosure provide a pixel structure and a driving method to maintain brightness and display quality of a display by improving problems associated with transistor variability and aging of an AMOLED display, and to improve the problem of the aperture ratio of pixels decreasing due to the number of transistors in the pixel structure being high.

These and other features, aspects, and advantages of the present invention, as well as the technical means and embodiments employed by the present invention, will become better understood with reference to the following description in connection with the accompanying drawings and appended claims.

### BRIEF DESCRIPTION OF THE DRAWINGS

The invention can be more fully understood by reading the following detailed description of the embodiment, with reference made to the accompanying drawings as follows:

FIG. 1A is a schematic diagram of a pixel structure according to embodiments of the present invention.

FIG. 1B is a schematic diagram of experimental data of emitting time and brightness of a light-emitting diode according to embodiments of the present invention.

FIG. 1C is a specific circuit diagram of a pixel structure as shown in FIG. 1A according to embodiments of the present invention.

FIG. 2A is an operation diagram of a pixel structure as shown in FIG. 1C according to embodiments of the present invention.

FIG. 2B is an operation diagram of a pixel structure as shown in FIG. 1C according to embodiments of the present invention.

FIG. 2C is an operation diagram of a pixel structure as shown in FIG. 1C according to embodiments of the present invention.

FIG. 2D is an operation diagram of a pixel structure as shown in FIG. 1C according to embodiments of the present invention.

FIG. 2E is a control waveform diagram of a pixel structure as shown in FIG. 1C according to embodiments of the present invention.

FIG. 3A is a schematic diagram of a pixel structure according to embodiments of the present invention.

FIG. 3B is a specific circuit diagram of a pixel structure as shown in FIG. 3A according to embodiments of the present invention.

FIG. 4A is a schematic diagram of a pixel structure according to embodiments of the present invention.

FIG. 4B is a specific circuit diagram of a pixel structure as shown in FIG. 4A according to embodiments of the present invention.

FIG. 4C is a control waveform diagram of a pixel structure as shown in FIG. 4A according to embodiments of the present invention.

FIG. 5A is a schematic diagram of a pixel structure according to embodiments of the present invention.

FIG. 5B is a specific circuit diagram of a pixel structure as shown in FIG. 5A according to embodiments of the present invention.

FIG. 6A is a schematic diagram of a pixel structure according to embodiments of the present invention.

FIG. 6B is a specific circuit diagram of a pixel structure as shown in FIG. 6A according to embodiments of the present invention.

FIG. 7A is an operation diagram of a pixel structure as shown in FIG. 6B according to embodiments of the present invention.

FIG. 7B is an operation diagram of a pixel structure as shown in FIG. 6B according to embodiments of the present invention.

FIG. 7C is an operation diagram of a pixel structure as shown in FIG. 6B according to embodiments of the present invention.

FIG. 7D is a control waveform diagram of a pixel structure as shown in FIG. 6B according to embodiments of the present invention.

FIG. 8A is a schematic diagram of a pixel structure according to embodiments of the present invention.

FIG. 8B is a specific circuit diagram of a pixel structure as shown in FIG. 8A according to embodiments of the present invention.

FIG. 9A is a schematic diagram of a pixel structure according to embodiments of the present invention.

FIG. 9B is a specific circuit diagram of a pixel structure as shown in FIG. 9A according to embodiments of the present invention.

FIG. 10 is a flow diagram illustrating the process steps of a driving method according to embodiments of the present disclosure.

In accordance with common practice, the various described features/elements are not drawn to scale but instead are drawn to best illustrate specific features/elements relevant to the present invention. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include singular forms of the same.

A 7T1C (seven transistors and one capacitors) configuration is used in the conventional pixel structure in order to compensate for a threshold voltage of driving transistors so as to maintain brightness and display quality of a display by improving the problems associated with transistor variability and aging of an AMOLED display. However, there is a problem that the aperture ratio of pixels is decreased due to the 7T1C configuration. A resetting unit of a pixel structure of the present invention can provide resetting signals and negative bias to a light-emitting diode, such that the number of transistors can be reduced, and gate lines connected to transistors for controlling the transistors can be correspondingly decreased. Hence, the aperture ratio of a display with the pixel structure of the present invention can be enhanced. The pixel structure will be described in detail below.

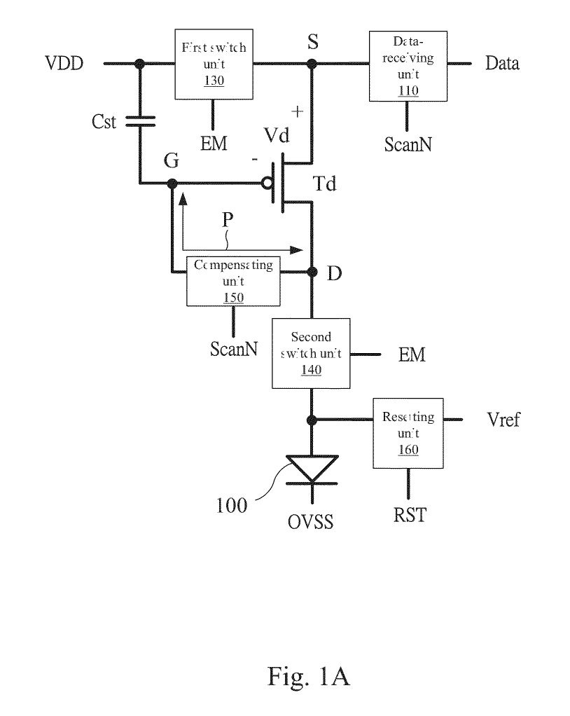

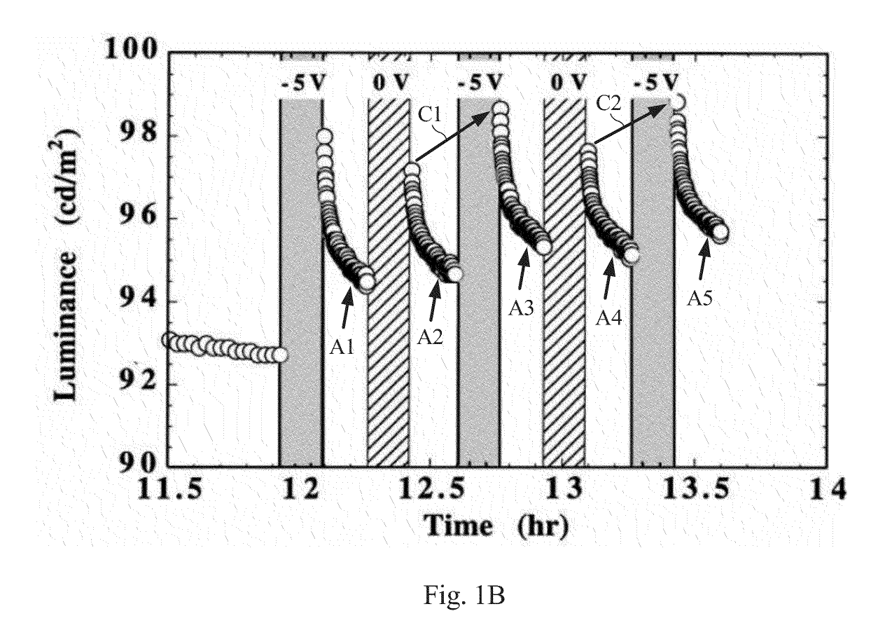

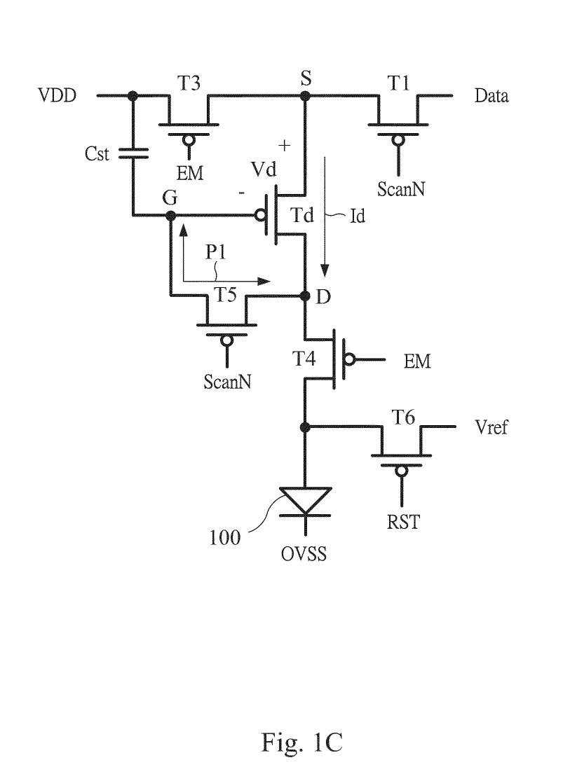

FIG. 1A is a schematic diagram of a pixel structure according to embodiments of the present invention. As shown in the figure, the pixel structure includes a light-emitting diode 100, a drive transistor Td, a data-receiving unit 110, a compensating unit 150 and a resetting unit 160. The drive transistor Td includes a control terminal G, a first terminal S and a second terminal D. The drive transistor Td is electrically coupled to the light-emitting diode 100, and drives the light-emitting diode 100 according to the voltage difference Vd between the control terminal G and the first terminal S of the drive transistor Td. The data-receiving unit 110 is electrically coupled to the first terminal S of the drive transistor Td, and provides the pixel data signal Data to the first terminal S of the drive transistor Td according to the first scan signal ScanN. The compensating unit 150 is electrically coupled to the control terminal G and the second terminal D of the drive transistor Td, and is used to function as a current path P between the control terminal G and the second terminal D of the drive transistor Td. The resetting unit 160 is electrically coupled to the light-emitting diode 100, and is used to cause the light-emitting diode 100 be in a state of reverse bias, and to provide a reference voltage Vref to the control terminal G of the drive transistor Td.

Reference is now made to FIG. 1B for describing an operation of the light-emitting diode 100 of the present invention when the light-emitting diode 100 receives a reverse bias voltage. FIG. 1B is a schematic diagram of experimental data of emitting time and brightness of the light-emitting diode 100 according to embodiments of the present invention. As shown in the figure, curves A1, A3 and A5 are experimental data curves composed of detecting points of light-emitting time and brightness of the light-emitting diode 100 when the light-emitting diode 100 receives −5V (volt) (where −5V is said reverse bias voltage). On the other hand, curves A2 and A4 are experimental data curves composed of detecting points of light-emitting time and brightness of the light-emitting diode 100 when the light-emitting diode 100 receives 0V.

As can be seen from curves A1˜A5, an increase in the light-emitting time of the light-emitting diode 100 results in a corresponding decrease in the brightness of the light-emitting diode 100. Moreover, a comparison result of the curves A2 and A3 is indicated by the arrow C1. As shown by the arrow C1, the brightness of the light-emitting diode 100 when the light-emitting diode 100 receives a reverse bias voltage is higher than the brightness of the light-emitting diode 100 when the light-emitting diode 100 receives 0V. Similarly, a comparison result of the curves A4 and A5 is indicated by the arrow C2. As shown by the arrow C2, the brightness of the light-emitting diode 100 when the light-emitting diode 100 receives a reverse bias voltage is higher than the brightness of the light-emitting diode 100 when the light-emitting diode 100 receives 0V. In view of above, the brightness of the light-emitting diode 100 when the light-emitting diode 100 receives a reverse bias voltage is higher than the brightness of the light-emitting diode 100 when the light-emitting diode 100 receives 0V. Hence, if the brightness of the two decreases at the same rate, the light-emitting diode 100 with a higher brightness has a longer lifespan. As can be seen above, the brightness of the light-emitting diode 100 is higher when reverse biased, and the light-emitting diode 100 has a longer lifespan. On the basis of the above-mentioned principle, the resetting unit 160 used in the pixel structure of the present invention provides a reverse bias voltage to the light-emitting diode 100 for prolonging the lifespan of the light-emitting diode 100. In one embodiment, to cause the light-emitting diode 100 to be in a state of reverse bias, the value of the voltage of the reference voltage Vref provided by the resetting unit 160 is lower than a source voltage OVSS, such that the light-emitting diode 100 is in a state of reverse bias.

In one embodiment, referring to FIG. 1A, the pixel structure further includes a first switch unit 130, a second switch unit 140 and a capacitor Cst. The first switch unit 130 includes a first terminal, a second terminal and a control terminal. The first terminal of the first switch unit 130 is configured to receive a first power voltage VDD. The second terminal of the first switch unit 130 is electrically coupled to the first terminal S of the drive transistor Td. The control terminal of the first switch unit 130 is configured to receive a second scan signal EM, and provide the first power voltage VDD to the drive transistor Td according to the second scan signal EM. The second switch unit 140 is electrically coupled between the second terminal D of the drive transistor Td and the light-emitting diode 100, and configured to connect the second terminal D of the drive transistor Td and the light-emitting diode 100 according to the second scan signal EM. The capacitor Cst is electrically coupled between the first terminal of the first switch unit 130 and the control terminal G of the drive transistor Td.

In another embodiment, again referring to FIG. 1A, the resetting unit 160 includes a first terminal, a second terminal and a control terminal. The first terminal of the resetting unit 160 is configured to receive the reference voltage Vref. The second terminal of the resetting unit 160 is electrically coupled to the anode of the light-emitting diode 100. The control terminal of the resetting unit 160 is configured to receive a reset scan signal RST so as to transmit the reference voltage Vref from the first terminal of the resetting unit 160 to the second terminal of the resetting unit 160 according to the reset scan signal RST, such that the light-emitting diode 100 is caused to be in a reverse bias state. Moreover, the cathode of the light-emitting diode 100 is electrically coupled to a second source voltage OVSS.

FIG. 1C is a specific circuit diagram of a pixel structure as shown in FIG. 1A according to embodiments of the present invention. Referring to both FIG. 1A and FIG. 1C, the data-receiving unit 110 includes a first transistor T1, the first switch unit 130 includes a third transistor T3, the second switch unit 140 includes a fourth transistor T4, the compensating unit 150 includes a fifth transistor T5, and the resetting unit 160 includes a sixth transistor T6. Each of the transistors T1˜T6 includes a first terminal, a second terminal, and a control terminal. In addition, the capacitor Cst includes a first terminal and a second terminal. In one embodiment, each of the transistors T1˜T6 can be an N-type transistor or a P-type transistor depending on actual requirements.

The first terminal of the first transistor T1 is configured to receive a pixel data signal Data. The control terminal of the first transistor T1 is configured to receive a first scan signal ScanN so as to transmit the pixel data signal Data from the first terminal to the second terminal according to the first scan signal ScanN. The first terminal S of the drive transistor Td is electrically coupled to the second terminal of the first transistor T1. The drive transistor Td is configured to drive the light-emitting diode 100 according to the voltage difference Vd between the control terminal G and the first terminal S of the drive transistor Td. The first terminal of the third transistor T3 is configured to receive a first power voltage VDD. The second terminal of the third transistor T3 is electrically coupled to the first terminal S of the drive transistor Td. The control terminal of the third transistor T3 is configured to receive the second scan signal EM so as to provide the first power voltage VDD to the drive transistor Td according to the second scan signal EM. The first terminal of the capacitor Cst is electrically coupled to the first terminal of the third transistor T3. The second terminal of the capacitor Cst is electrically coupled to the control terminal G of the drive transistor Td.

In addition, the first terminal of the fourth transistor T4 is electrically coupled to the second terminal D of the drive transistor Td. The second terminal of the fourth transistor T4 is electrically coupled to the light-emitting diode 100. The control terminal of the fourth transistor T4 is configured to receive the second scan signal EM so as to provide a driving current Id to the light-emitting diode 100 according to the second scan signal EM. The first terminal of the fifth transistor T5 is electrically coupled to the second terminal D of the drive transistor Td. The second terminal of the fifth transistor T5 is electrically coupled to the control terminal G of the drive transistor Td. The control terminal of the fifth transistor T5 is configured to receive the first scan signal ScanN, and the fifth transistor T5 is turned on according to the first scan signal ScanN, such that there is a path P1 from the first terminal to the second terminal of the fifth transistor T5. The sixth transistor T6 is configured to cause the light-emitting diode 100 to be in a state of reverse bias, and to provide a reference voltage Vref to the control terminal G of the drive transistor Td.

In one embodiment, the sixth transistor T6 includes a first terminal, a second terminal and a control terminal. The first terminal of the sixth transistor T6 is configured to receive the reference voltage Vref. The second terminal of the sixth transistor T6 is electrically coupled to the second terminal of the fourth transistor T4. The control terminal of the sixth transistor T6 is configured to receive a reset scan signal RST so as to transmit the reference voltage Vref from the first terminal of the sixth transistor T6 to the second terminal of the sixth transistor T6 according to the reset scan signal RST, resulting in the light-emitting diode 100 being in a state of reverse bias.

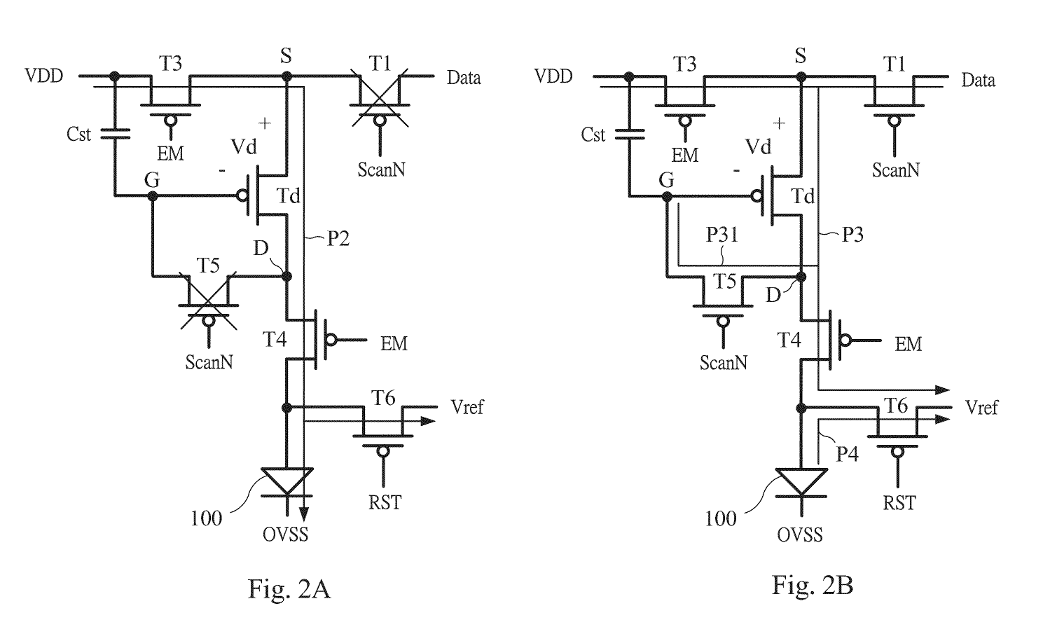

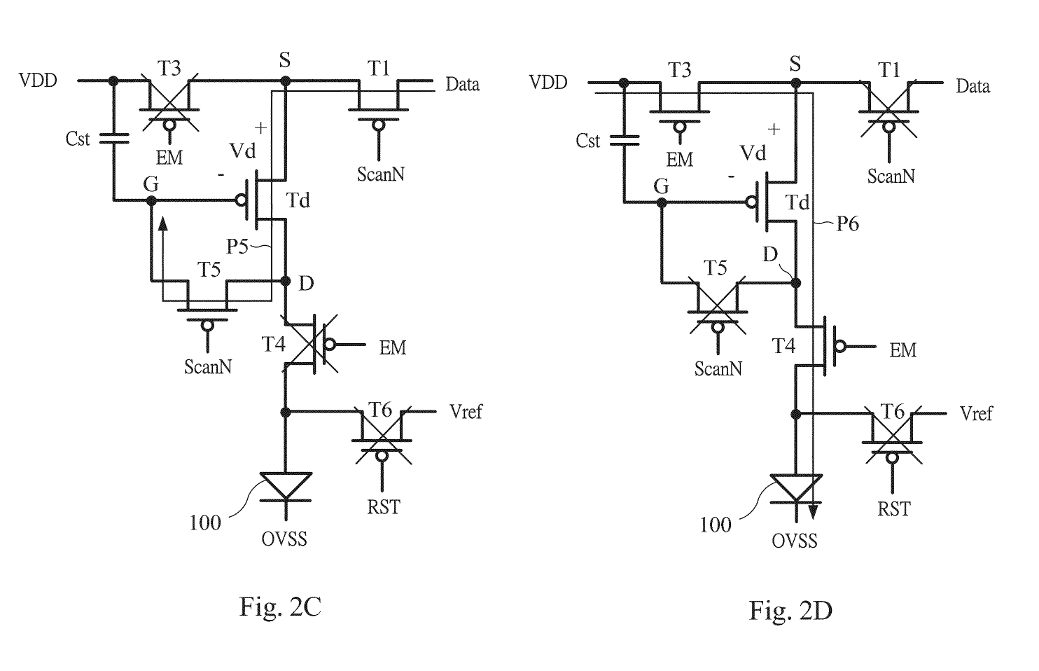

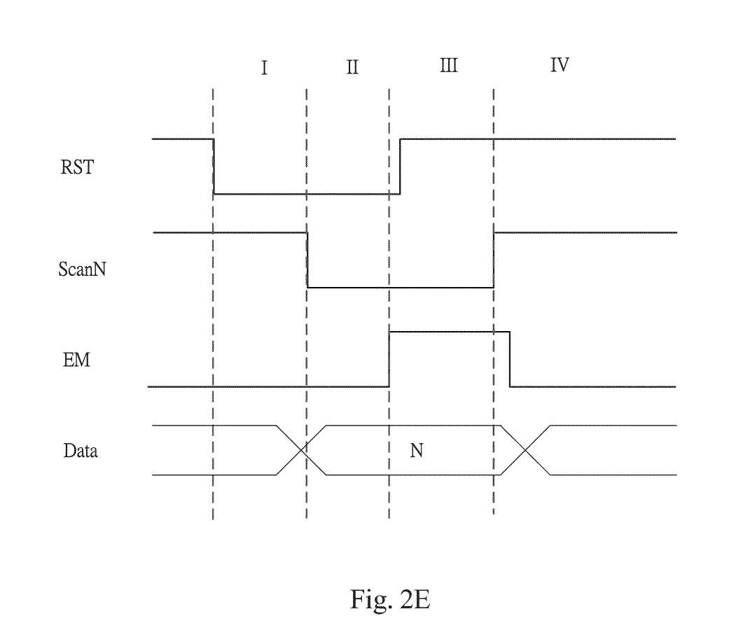

FIG. 2A-FIG. 2D are operation diagrams of a pixel structure as shown in FIG. 1C according to embodiments of the present invention. FIG. 2E is a control waveform diagram of a pixel structure as shown in FIG. 1C according to embodiments of the present invention. Referring to the first stage I of FIG. 2E, the main purpose herein is to reset the anode of the light-emitting diode 100. In the first stage I, the reset scan signal RST is at a low level, and the first scan signal ScanN is at a high level, and the second scan signal EM is at a low level. Referring to FIG. 2A, the first transistor T1 and the fifth transistor T5 are turned off according to the first scan signal ScanN which is at a high level. The third transistor T3 and the fourth transistor T4 are turned on according to the second scan signal EM which is at a low level. The sixth transistor T6 is turned on according to the reset scan signal RST which is at a low level. A path P2 is formed in the pixel structure circuit according to the turned-on or turned-off states of the transistors. Meanwhile, the voltage of the second terminal D of the drive transistor Td and the anode of the light-emitting diode 100 are the reference voltage Vref.

Referring to the second stage II of FIG. 2E, the main purpose herein is to reset the control terminal G of the drive transistor Td. In the second stage II, the reset scan signal RST is at a low level, the first scan signal ScanN is at a low level, and the second scan signal EM is at a low level. Referring to FIG. 2B, the first transistor T1 and the fifth transistor T5 are turned on according to the first scan signal ScanN which is at a low level. The third transistor T3 and the fourth transistor T4 are turned on according to the second scan signal EM which is at a low level. The sixth transistor T6 is turned on according to the reset scan signal RST which is at a low level. Paths P3 and P4 are formed in the pixel structure circuit according to the turned-on or turned-off states of the transistors. Meanwhile, the voltage of the control terminal G of the drive transistor Td is pulled to a low voltage VL according to a sub-path P31 of the path P3. In addition, the voltage of the second terminal D of the drive transistor Td and the anode of the light-emitting diode 100 are the low voltage VL. In one embodiment, the low voltage VL is slightly higher than the reference voltage Vref.

Referring to the third stage III of FIG. 2E, the main purpose herein is to write the data signal Data into the control terminal G of the drive transistor Td. In the third stage III, the reset scan signal RST is at a high level, the first scan signal ScanN is at a low level, and the second scan signal EM is at a high level. Referring to FIG. 2C, the first transistor T1 and the fifth transistor T5 are turned on according to the first scan signal ScanN which is at a low level. The third transistor T3 and the fourth transistor T4 are turned off according to the second scan signal EM which is at a high level. The sixth transistor T6 is turned off according to the reset scan signal RST which is at a high level. A path P5 is formed in the pixel structure circuit according to the turned-on or turned-off states of the transistors. Meanwhile, the data signal Data is written into the control terminal G of the drive transistor Td via the path P5, such that the voltage of the control terminal G of the drive transistor Td is substantially Data−Vth (Vth is the threshold voltage of the drive transistor Td). In addition, the voltage of the first terminal S of the drive transistor Td is Data, and the voltage of the anode of the light-emitting diode 100 is the low voltage VL.

Referring to the fourth stage IV of FIG. 2E, the main purpose herein is that the drive transistor Td provides current to the light-emitting diode 100 according to the voltage difference Vd between the first terminal S and the control terminal G of the drive transistor Td. In the fourth stage IV, the reset scan signal RST is at a high level, the first scan signal ScanN is at a high level, and the second scan signal EM is at a low level. Referring to FIG. 2D, the first transistor T1 and the fifth transistor T5 are turned off according to the first scan signal ScanN which is at a high level. The third transistor T3 and the fourth transistor T4 are turned on according to the second scan signal EM which is at a low level. The sixth transistor T6 is turned off according to the reset scan signal RST which is at a high level. A path P6 is formed in the pixel structure circuit according to the turned-on or turned-off states of the transistors. Meanwhile, the drive transistor Td provides a driving current to the light-emitting diode 100 according to the voltage difference Vd between the control terminal G and the first terminal S of the drive transistor Td. In addition, the voltage of the first terminal S of the drive transistor Td is VDD. The equation of the driving current is as shown below:

I_{OLED}=K(V_{SG}−Vth)² equation 1

In the equation 1, I_{OLED} is the driving current, V_{SG} is the voltage difference between the first terminal S and the control terminal G of the drive transistor Td, and Vth is the threshold voltage. In this stage, the voltage of the first terminal S of the drive transistor Td is VDD, and the voltage of the control terminal G of the drive transistor Td is substantially Data−Vth. Hence, V_{SG} is (VDD−Data+Vth). The following equation can be obtained by substituting V_{SG} into equation 1:

I_{OLED}=K(VDD−Data)² equation 2

As can be seen in equation 2, the pixel structure of the present invention in conjunction with a suitable driving method can eliminate a threshold voltage Vth. Hence, changes in the transistor threshold voltage will not affect the pixel structure of the present invention.

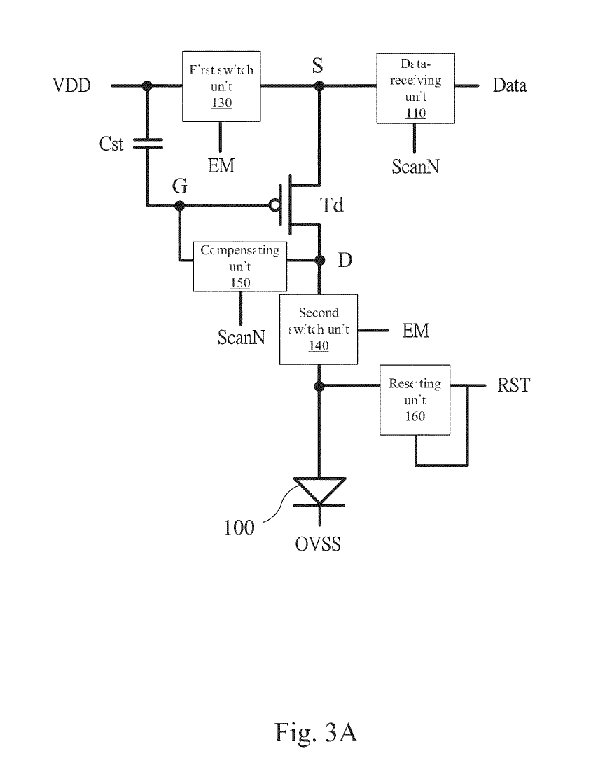

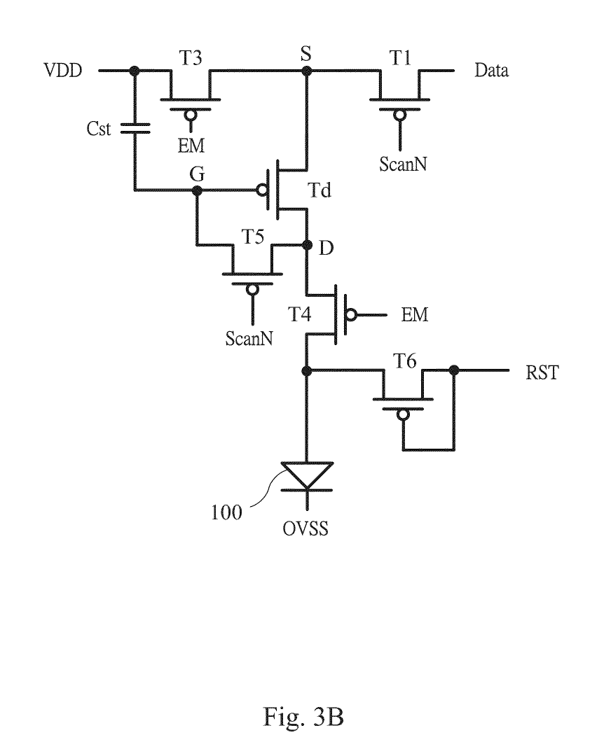

FIG. 3A is a schematic diagram of a pixel structure according to embodiments of the present invention. The disposition of the resetting unit 160 as shown in FIG. 3A is different from the disposition of the resetting unit 160 as shown in FIG. 1A. In this embodiment, the first terminal of the resetting unit 160 is configured to receive the reset scan signal RST, and the control terminal of the resetting unit 160 is electrically coupled to the first terminal of the resetting unit 160. Hence, the reset scan signal RST can be transmitted from the first terminal of the resetting unit 160 to the second terminal of the resetting unit 160.

FIG. 3B is a specific circuit diagram of a pixel structure as shown in FIG. 3A according to embodiments of the present invention. Referring to both FIG. 3A and FIG. 3B, the data-receiving unit 110 includes a first transistor T1. The first switch unit 130 includes a third transistor T3. The second switch unit 140 includes a fourth transistor T4. The compensating unit 150 includes a fifth transistor T5. The resetting unit 160 includes a sixth transistor T6. Each of the first to sixth transistors T1-T6 includes a first terminal, a second terminal and a control terminal. It is noted that the control wave of the pixel structure in FIG. 3B is similar to that of FIG. 2A to FIG. 2D, and therefore, a detailed description regarding the control wave of the pixel structure in FIG. 3B is omitted herein.

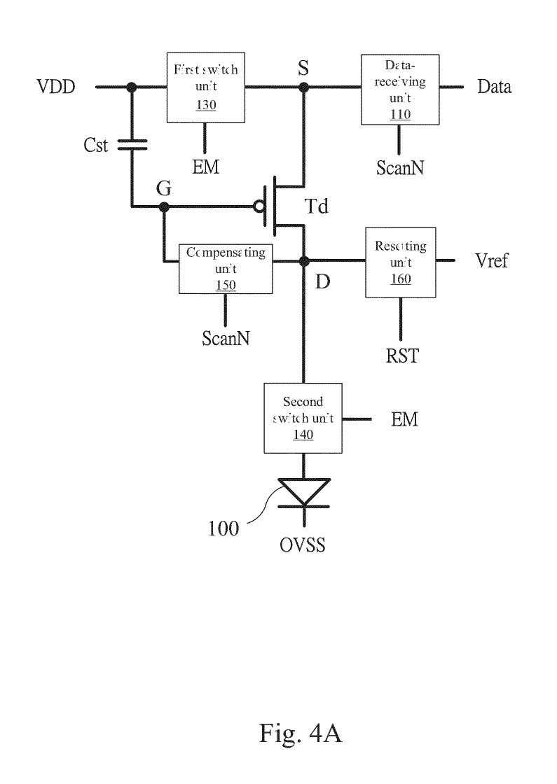

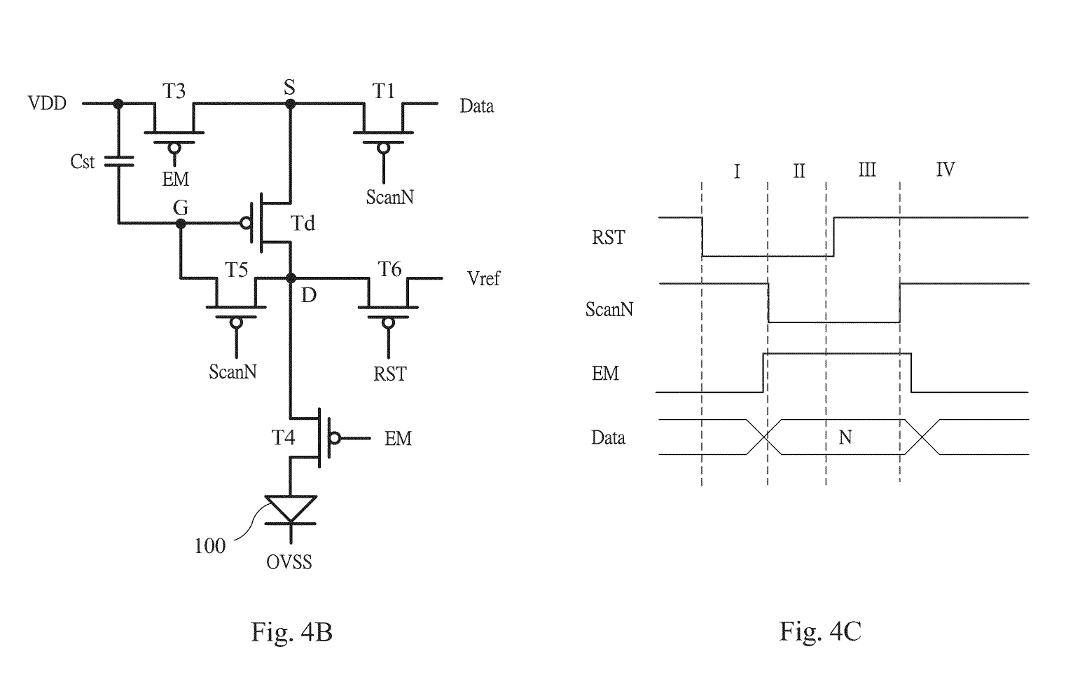

FIG. 4A is a schematic diagram of a pixel structure according to embodiments of the present invention. The configuration of the resetting unit 160 in FIG. 4A is different from that of FIG. 1A. In this embodiment, the second terminal of the resetting unit 160 is electrically coupled to the second terminal of the transistor T and the first terminal of the second switch unit 140.

FIG. 4B is a specific circuit diagram of a pixel structure as shown in FIG. 4A according to embodiments of the present invention. FIG. 4C is a control waveform diagram of a pixel structure as shown in FIG. 4A according to embodiments of the present invention. Referring to both FIG. 4A and FIG. 4B, the data-receiving unit 110 includes a first transistor T1. The first switch unit 130 includes a third transistor T3. The second switch unit 140 includes a fourth transistor T4. The compensating unit 150 includes a fifth transistor T5. The resetting unit 160 includes a sixth transistor T6. Each of the first to sixth transistors T1˜T6 includes a first terminal, a second terminal and a control terminal.

Additional reference is made to FIG. 4C. The control waveform in FIG. 4C is different from that in FIG. 2E, and the difference will be described below. The second scan signal EM of FIG. 4C is at a high level in the stage II. Hence, the third transistor T3 and the fourth transistor T4 are turned off according to the second scan signal EM which is at a level in the stage II. However, since the second terminal of the sixth transistor T6 of FIG. 4B is electrically coupled to the second terminal D of the drive transistor Td, and both the fifth transistor T5 and the sixth transistor T6 are turned on at this time, the pixel structure circuit is able to pull the voltage of the control terminal G of the drive transistor Td to a low voltage VL.

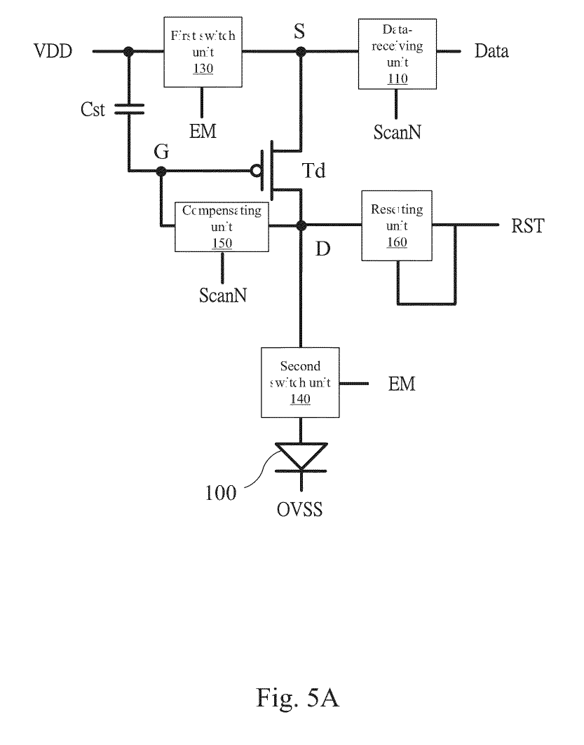

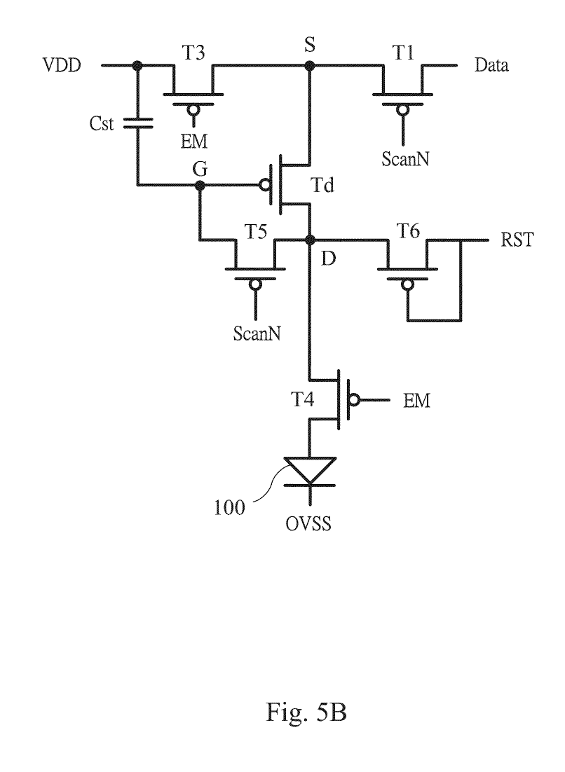

FIG. 5A is a schematic diagram of a pixel structure according to embodiments of the present invention. The configuration of the resetting unit 160 in FIG. 5A is different from the configuration of the resetting unit 160 in FIG. 4A. In this embodiment, the first terminal of the resetting unit 160 is configured to receive the reset scan signal RST. The control terminal of the resetting unit 160 is electrically coupled to the first terminal of the resetting unit 160. Hence, the reset scan signal RST can be transmitted from the first terminal of the resetting unit 160 to the second terminal of the resetting unit 160.

FIG. 5B is a specific circuit diagram of a pixel structure as shown in FIG. 5A according to embodiments of the present invention. Referring to FIG. 5A and FIG. 5B, the data-receiving unit 110 includes a first transistor T1. The first switch unit 130 includes a third transistor T3. The second switch unit 140 includes a fourth transistor T4. The compensating unit 150 includes a fifth transistor T5. The resetting unit 160 includes a sixth transistor T6. Each of the first to sixth transistors T1˜T6 includes a first terminal, a second terminal and a control terminal. It is noted that the control waveform of the pixel structure circuit of FIG. 5B is similar to the control waveform of FIG. 4B, and therefore, a detailed description regarding the control wave of the pixel structure in FIG. 5B is omitted herein

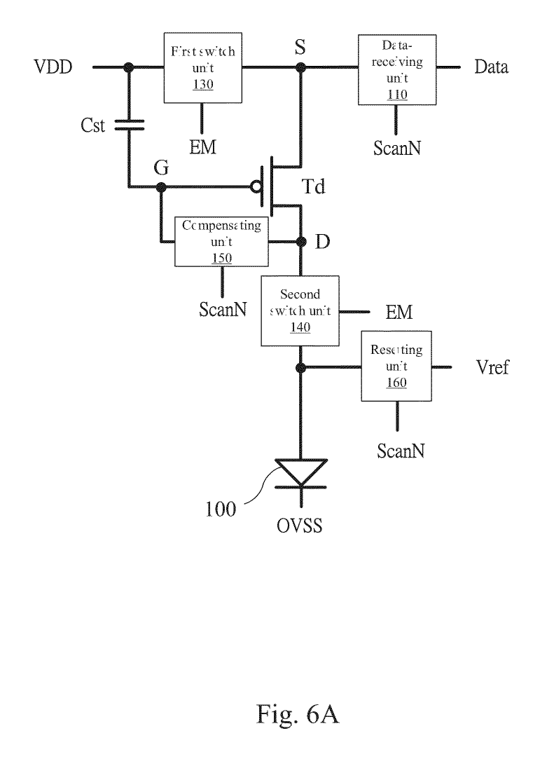

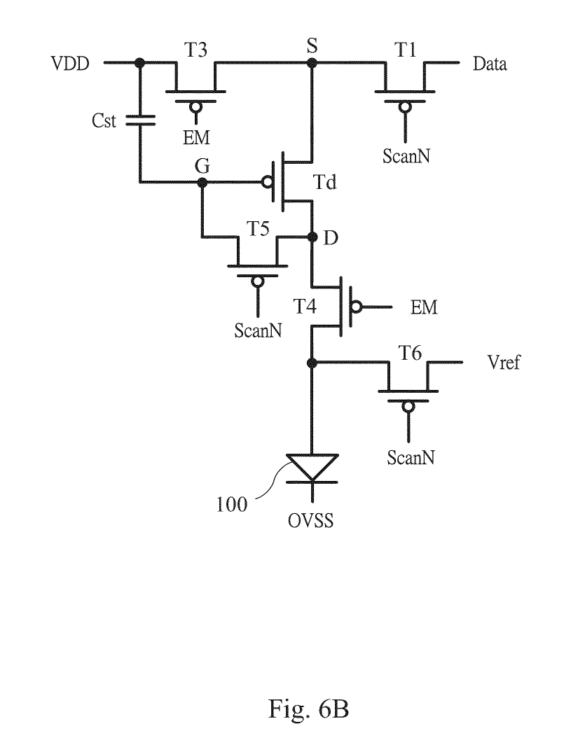

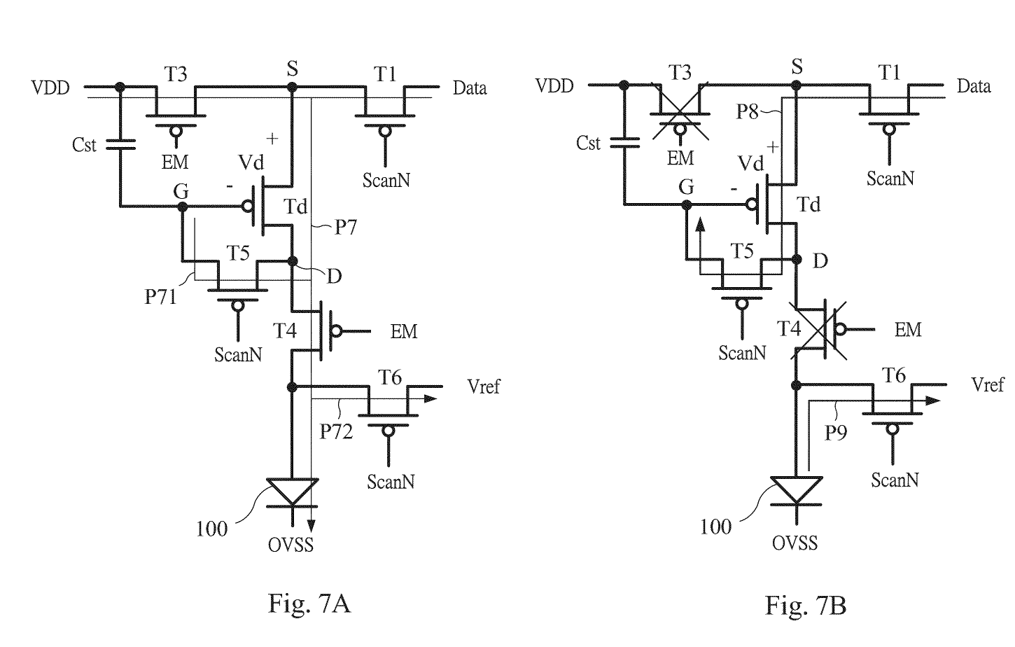

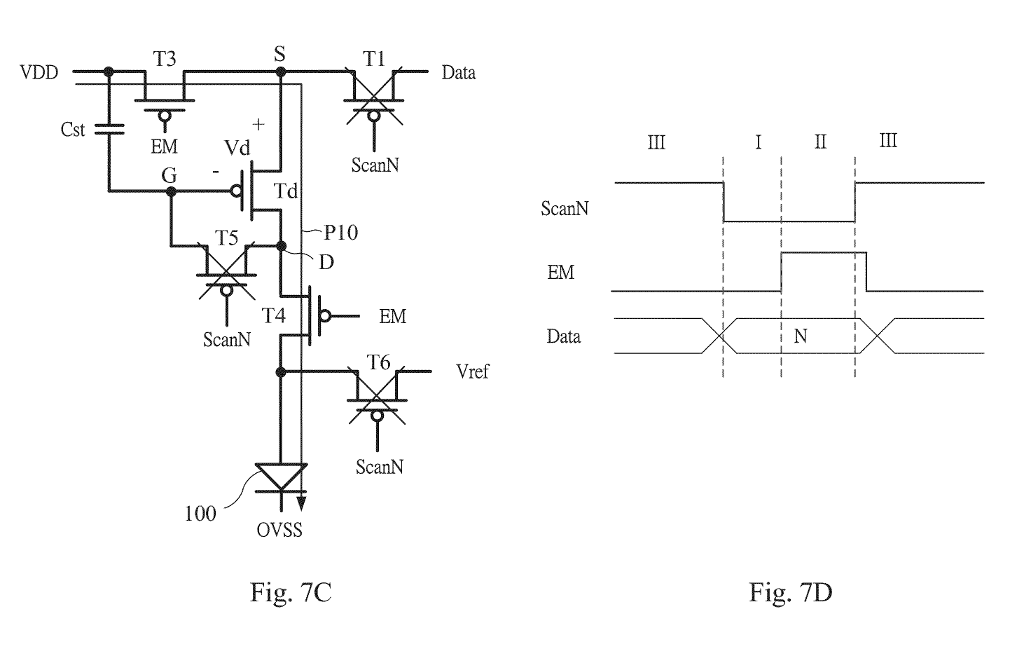

FIG. 6A is a schematic diagram of a pixel structure according to embodiments of the present invention. The driving signal received by the resetting unit 160 in FIG. 6A is different from that of FIG. 1A. In this embodiment, the control terminal of the resetting unit 160 is configured to receive the first scan signal ScanN, and transmit the reference voltage Vref from the first terminal of the resetting unit 160 to the second terminal of the resetting unit 160 according to the first scan signal ScanN. Hence, the manner of driving the pixel structure of FIG. 6A is different from that of FIG. 1A, and the difference will be described with reference to FIG. 7A to FIG. 7D.

FIG. 6B is a specific circuit diagram of a pixel structure as shown in FIG. 6A according to embodiments of the present invention. Referring to FIG. 6A and FIG. 6B, the data-receiving unit 110 includes a first transistor T1. The first switch unit 130 includes a third transistor T3. The second switch unit 140 includes a fourth transistor T4. The compensating unit 150 includes a fifth transistor T5. The resetting unit 160 includes a sixth transistor T6. Each of the first to sixth transistors T1˜T6 includes a first terminal, a second terminal and a control terminal.

FIG. 7A to FIG. 7C are operation diagrams of a pixel structure as shown in FIG. 6B according to embodiments of the present invention. FIG. 7D is a control waveform diagram of a pixel structure as shown in FIG. 6B according to embodiments of the present invention. Referring to the first stage I of FIG. 7D, the main purpose herein is to reset the control terminal G of the drive transistor Td and the anode of the light-emitting diode 100. In the first stage I, the first scan signal ScanN is at a low level, and the second scan signal EM is at a low level. Referring to the left part of the pixel structure circuit, the first transistor T1, the fifth transistor T5 and the sixth transistor T6 are turned on according to the first scan signal ScanN which is at a low level. The third transistor T3 and the fourth transistor T4 are turned on according to the second scan signal EM which is at a low level. A path P7 is formed in the pixel structure circuit according to the turned on state of the transistor. Meanwhile, the voltage of the control terminal G of the drive transistor Td is pulled to a low voltage VL according to a sub-path path P71 of the path P7, and the voltage of the anode of the light-emitting diode 100 is pulled to a low voltage VL according to a sub-path P72 of the path P7. In one embodiment, the low voltage VL is slightly higher than the reference voltage Vref.

Referring to the second stage II of FIG. 7D, the main purpose herein is to write the data signal Data into the control terminal G of the drive transistor Td. In the second stage II, the first scan signal ScanN is at a low level, and the second scan signal EM is at a high level. Referring to FIG. 7B, the first transistor T1, the fifth transistor T5 and the sixth transistor T6 are turned on according to the first scan signal ScanN which is at a low level, and the third transistor T3 and the fourth transistor T4 are turned off according to the second scan signal EM which is at a high level. Paths P8, P9 are formed in the pixel structure circuit according to the turned-on or turned-off states of the transistors. Meanwhile, the data signal Data is written into the control terminal G of the drive transistor Td via the path P8, such that the voltage of the control terminal G of the drive transistor Td is substantially Data−Vth (Vth is the threshold voltage of the drive transistor Td), the voltage of the first terminal S of the drive transistor Td is Data, and the voltage of the second terminal D of the drive transistor Td is substantially Data−Vth. In addition, referring to the path P9, the voltage of the anode of the light-emitting diode 100 is the reference voltage Vref.

Referring to the third stage III of FIG. 7D, the main purpose herein is that the drive transistor Td provides current to the light-emitting diode 100 according to the voltage difference Vd between the first terminal S and the control terminal G of the drive transistor Td. In the third stage III, the first scan signal ScanN is at a high level, and second scan signal EM is at a low level. Referring to FIG. 7C, the first transistor T1, the fifth transistor T5 and the sixth transistor T6 are turned off according to the first scan signal ScanN which is at a high level, and the third transistor T3 and the fourth transistor T4 are turned on according to the second scan signal EM which is at a low level. A path P10 is formed in the pixel structure circuit according to the turned-on or turned-off states of the transistors. Meanwhile, the drive transistor Td provides a driving current to the light-emitting diode 100 according to the voltage difference Vd between the control terminal G and the first terminal S of the drive transistor Td. In addition, the voltage of the first terminal S of the drive transistor Td is VDD. The equation of the driving current is as shown in equation 1. In this stage, the voltage of the first terminal S of the drive transistor Td is VDD, and the voltage of the control terminal G of the drive transistor Td is substantially Data−Vth. Hence, V_{SG} is (VDD−Data+Vth), and equation 2 can be obtained by substituting V_{SG} into equation 1. As can be seen in equation 2, the pixel structure of the present invention in conjunction with a suitable method manner can eliminate a threshold voltage Vth. Hence, variability in the transistor threshold voltage will not affect the pixel structure of the present invention.

Referring again to FIG. 7D, before the third stage III, the voltage of the first scan signal ScanN is maintained at a low level, and the sixth transistor T6 provides the reference voltage Vref to the light-emitting diode 100. Hence, the light-emitting diode 100 is in a low voltage state before the third stage III so as to avoid a light leakage phenomenon at a low gray level.

Compared with FIG. 2E, a reduction of a control stage is realized with the control waveform in FIG. 7D. Reducing a control stage in FIG. 7D is achieved by optimizing the configuration of the pixel structure of the present invention. Specifically, the first stage and the second stage in FIG. 2E are respectively used to “reset the anode of the light-emitting diode 100” and “reset the control terminal G of the drive transistor Td.” However, in the embodiment of FIG. 7D, a single control stage (for example, the first stage I) is used to “reset the control terminal G of the drive transistor Td and the anode of the light-emitting diode 100.” Hence, the pixel structure of the present invention can reduce a control stage for enhancing driving efficiency of the pixel structure of the present invention.

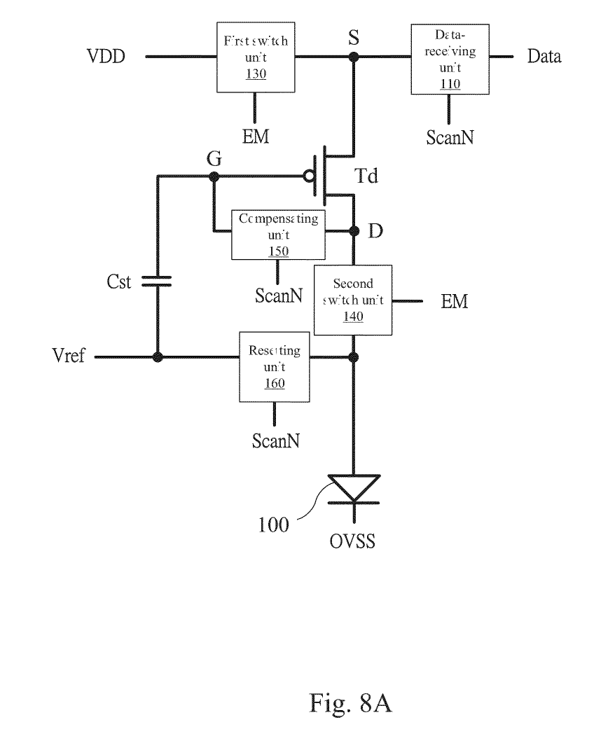

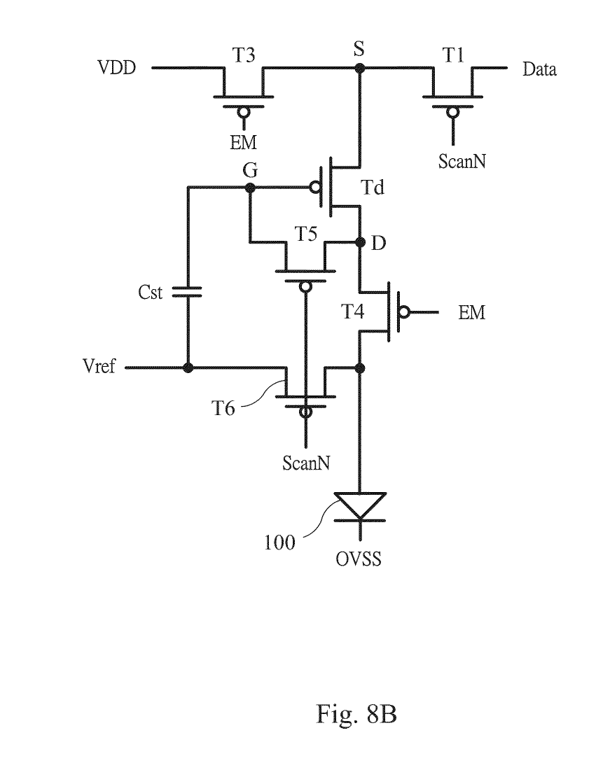

FIG. 8A is a schematic diagram of a pixel structure according to embodiments of the present invention. The configuration of the capacitor Cst of FIG. 8A is different from the configuration of the capacitor Cst of FIG. 6A. In this embodiment, the first terminal of the capacitor Cst is electrically coupled to the control terminal of the transistor T, and the second terminal of the capacitor Cst is electrically coupled to the second terminal of the resetting unit 160.

FIG. 8B is a specific circuit diagram of a pixel structure as shown in FIG. 8A according to embodiments of the present invention. Referring to FIG. 8A and FIG. 8B, the data-receiving unit 110 includes a first transistor T1. The first switch unit 130 includes a third transistor T3. The second switch unit 140 includes a fourth transistor T4. The compensating unit 150 includes a fifth transistor T5. The resetting unit 160 includes a sixth transistor T6. Each of the first to sixth transistors T1˜T6 includes a first terminal, a second terminal and a control terminal. It is noted that the control wave of the pixel structure in FIG. 8B is similar to that of FIG. 7A to FIG. 7C, and therefore, a detailed description regarding the control wave of the pixel structure in FIG. 8B is omitted herein.

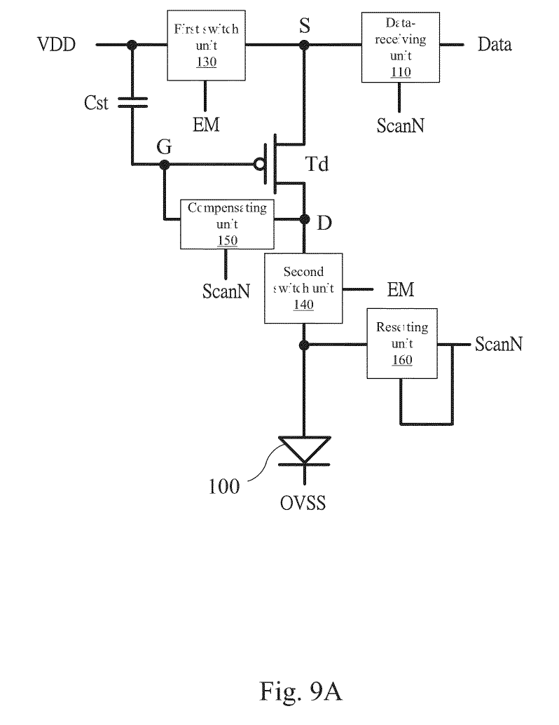

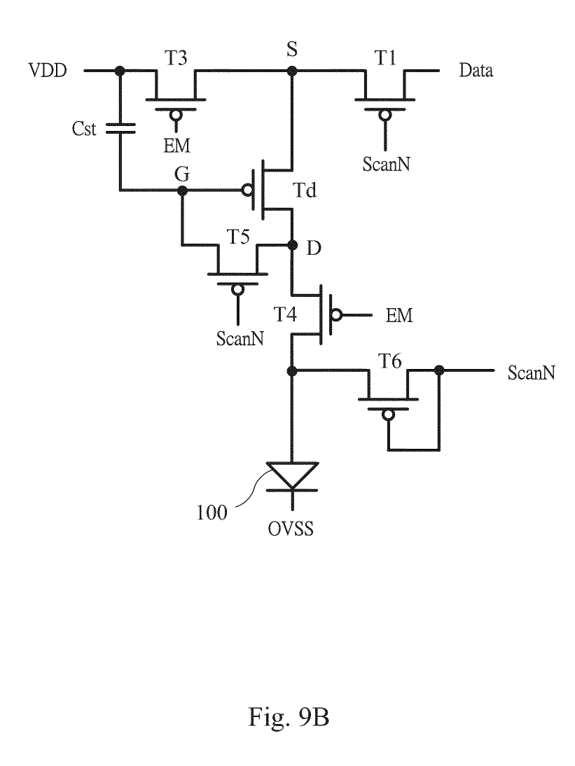

FIG. 9A is a schematic diagram of a pixel structure according to embodiments of the present invention. The configuration of the resetting unit 160 of FIG. 9A is different from that of FIG. 6A. In this embodiment, the first terminal of the resetting unit 160 is configured to receive the first scan signal ScanN. The control terminal of the resetting unit 160 is electrically coupled to the first terminal of the resetting unit 160. Hence, the first scan signal ScanN can be transmitted from the first terminal of the resetting unit 160 to the second terminal of the resetting unit 160.

FIG. 9B is a specific circuit diagram of a pixel structure as shown in FIG. 9A according to embodiments of the present invention. Referring to FIG. 9A and FIG. 9B, the data-receiving unit 110 includes a first transistor T1. The first switch unit 130 includes a third transistor T3. The second switch unit 140 includes a fourth transistor T4. The compensating unit 150 includes a fifth transistor T5. The resetting unit 160 includes a sixth transistor T6. Each of the first to sixth transistors T1˜T6 includes a first terminal, a second terminal and a control terminal. It is noted that the control wave of the pixel structure of FIG. 9B is similar to that of FIG. 7A to FIG. 7C, and therefore, a detailed description regarding the control wave of the pixel structure in FIG. 9B is omitted herein.

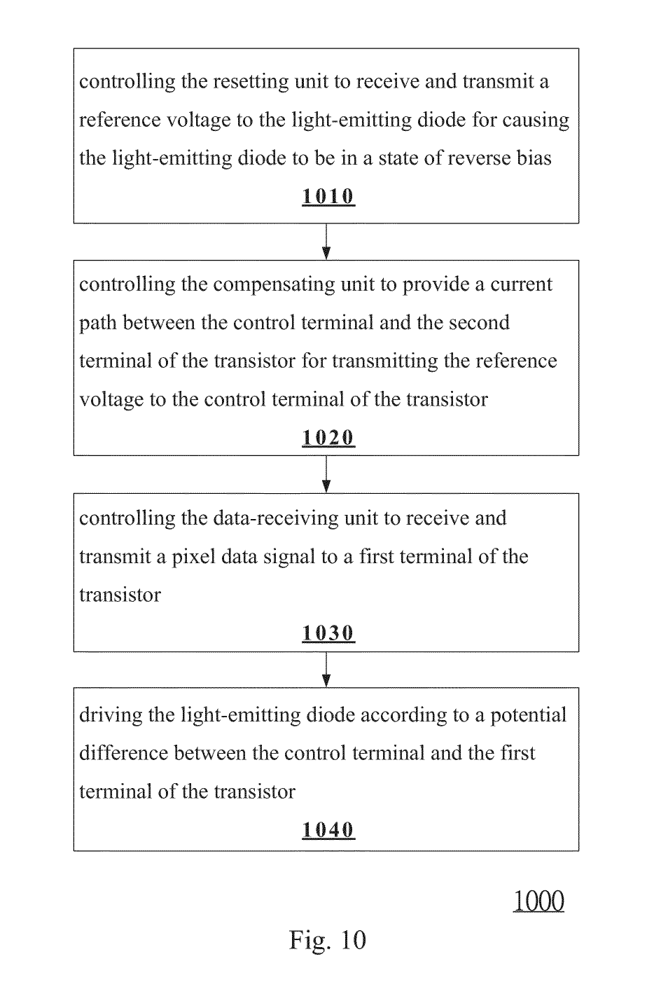

FIG. 10 is a flow diagram illustrating the process steps of a driving method according to embodiments of the present disclosure. The driving method 1000 includes the steps of:

step 1010: controlling the resetting unit to receive and transmit a reference voltage to the light-emitting diode for causing the light-emitting diode to be in a state of reverse bias;

step 1020: controlling the compensating unit to provide a current path between the control terminal and the second terminal of the transistor for transmitting the reference voltage to the control terminal of the transistor;

step 1030: controlling the data-receiving unit to receive and transmit a pixel data signal to a first terminal of the transistor; and

step 1040: driving the light-emitting diode according to a voltage difference between the control terminal and the first terminal of the transistor.

For facilitating the understanding of the driving method 1000 of the present invention, reference is now made to both FIG. 1A and FIG. 10. In step 1010, the driving method 1000 is performed with the reset scan signal RST for controlling the resetting unit 160 to receive and transmit the reference voltage Vref to the light-emitting diode 100 for causing the light-emitting diode 100 to be in a state of reverse bias. In step 1020, the driving method 1000 is performed with the first scan signal ScanN for controlling the compensating unit 150 to provide a current path P between the control terminal G and the second terminal D of the transistor T for transmitting the reference voltage Vref to the control terminal G of the transistor T. In step 1030, the driving method 1000 is performed with the first scan signal ScanN for controlling the data-receiving unit 110 to receive and transmit a pixel data signal Data to a first terminal S of the transistor T. In step 1040, the driving method 1000 drives the light-emitting diode 100 according to a voltage difference Vd between the control terminal G and the first terminal S of the transistor T.

As may be appreciated by persons having ordinary skill in the art, the steps of the driving method 1000 are named according to the function they perform, and such naming is provided to facilitate the understanding of the present disclosure but not to limit the steps. Combining the step into a single step or dividing any one of the steps into multiple steps, or switching any step so as to be a part of another step falls within the scope of the embodiments of the present disclosure.

In view of the above embodiments of the present disclosure, it is apparent that the application of the present invention has a number of advantages. Embodiments of the present invention provide a pixel structure and a driving method to maintain brightness and display quality of display by improving the problems associated with transistor variability and aging of an AMOLED display, and to improve the problem of the aperture ratio of pixels decreasing due to the number of transistors in the pixel structure being high.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A pixel structure, comprising:
a light-emitting diode;
a first transistor comprising:
a first terminal configured to receive a pixel data signal;
a second terminal; and
a control terminal configured to receive a first scan signal so as to transmit the pixel data signal from the first terminal to the second terminal according to the first scan signal;
a second transistor comprising a first terminal, a second terminal and a control terminal, and configured to drive the light-emitting diode according to a voltage difference between the control terminal and the first terminal of the second transistor, wherein the first terminal of the second transistor is electrically coupled to the second terminal of the first transistor;
a third transistor comprising:
a first terminal configured to receive a first power voltage;
a second terminal electrically coupled to the first terminal of the second transistor; and
a control terminal configured to receive a second scan signal so as to provide the first power voltage to the second transistor according to the second scan signal;
a fourth transistor comprising:
a first terminal electrically coupled to the second terminal of the second transistor;
a second terminal electrically coupled to the light-emitting diode; and
a control terminal configured to receive the second scan signal so as to provide a driving current to the light-emitting diode according to the second scan signal;
a fifth transistor comprising:
a first terminal electrically coupled to the second terminal of the second transistor;
a second terminal electrically coupled to the control terminal of the second transistor; and
a control terminal configured to receive the first scan signal so as to turn on a path between the first terminal of the fifth transistor and the second terminal of the fifth transistor according to the first scan signal;
a sixth transistor configured to cause the light-emitting diode to be in a state of reverse bias, and provide a reference voltage to the control terminal of the second transistor; and
a capacitor comprising:
a first terminal electrically coupled to the first terminal of the third transistor or the sixth transistor; and
a second terminal electrically coupled to the control terminal of the second transistor.

2. The pixel structure of claim 1, wherein the sixth transistor comprises:
a first terminal configured to receive the reference voltage;
a second terminal electrically coupled to the second terminal of the fourth transistor; and
a control terminal configured to receive a reset scan signal or the first scan signal so as to transmit the reference voltage from the first terminal of the sixth transistor to the second terminal of the sixth transistor according to the reset scan signal or the first scan signal.

3. The pixel structure of claim 1, wherein the sixth transistor comprises:
a first terminal configured to receive the reset scan signal;
a second terminal electrically coupled to the second terminal of the fourth transistor; and
a control terminal electrically coupled to the first terminal of the sixth transistor, wherein the reset scan signal or the first scan signal is transmitted from the first terminal of the sixth transistor to the second terminal of the sixth transistor.

4. The pixel structure of claim 1, wherein the sixth transistor comprises:
a first terminal configured to receive the reference voltage;
a second terminal electrically coupled to the second terminal of the second transistor; and
a control terminal configured to receive a reset scan signal so as to transmit the reference voltage from the first terminal of the sixth transistor to the second terminal of the sixth transistor according to the reset scan signal.

5. The pixel structure of claim 1, wherein the sixth transistor comprises:
a first terminal configured to receive a reset scan signal;
a second terminal electrically coupled to the second terminal of the second transistor; and
a control terminal electrically coupled to the first terminal of the sixth transistor, wherein the reset scan signal is transmitted from the first terminal of the sixth transistor to the second terminal of the sixth transistor.

6. A pixel structure comprising:
a light-emitting diode;
a transistor electrically coupled to the light-emitting diode, wherein the transistor comprises a control terminal, a first terminal and a second terminal, and is configured to drive the light-emitting diode according to a voltage difference between the control terminal and the first terminal of the transistor;
a data-receiving unit electrically coupled to the first terminal of the transistor, and configured to provide a pixel data signal to the first terminal of the transistor according to a first scan signal;
a compensating unit electrically coupled to the control terminal and the second terminal of the transistor, and configured to be a current path between the control terminal and the second terminal of the transistor; and
a resetting unit electrically coupled to the light-emitting diode or the second terminal of the transistor, wherein the resetting unit is configured to cause the light-emitting diode to be in a state of reverse bias, and provide a reference voltage to the control terminal of the transistor.

7. The pixel structure of claim 6, further comprising a first switch unit, wherein the first switch unit comprises:
a first terminal configured to receive a first power voltage;
a second terminal electrically coupled to the first terminal of the transistor; and
a control terminal configured to receive a second scan signal so as to provide the first power voltage to the transistor according to the second scan signal.

8. The pixel structure of claim 6, further comprising a second switch unit, wherein the second switch unit is electrically coupled between the second terminal of the transistor and the light-emitting diode, and configured to connect the second terminal of the transistor and the light-emitting diode according to the second scan signal.

9. The pixel structure of claim 6, further comprising a capacitor, wherein the capacitor is electrically coupled between the first terminal of the first switch unit and the control terminal of the transistor.

10. The pixel structure of claim 6, further comprising a capacitor, wherein the capacitor comprises:
a first terminal electrically coupled to the control terminal of the transistor; and
a second terminal electrically coupled to the resetting unit.

11. The pixel structure of claim 6, wherein the resetting unit comprises:
a first terminal configured to receive a reference voltage;
a second terminal electrically coupled to the light-emitting diode; and
a control terminal configured to receive a reset scan signal or the first scan signal so as to transmit the reference voltage from the first terminal of the resetting unit to the second terminal of the resetting unit according to the reset scan signal or the first scan signal.

12. The pixel structure of claim 6, wherein the resetting unit comprises:
a first terminal configured to receive a reset scan signal;
a second terminal electrically coupled to the light-emitting diode; and
a control terminal electrically coupled to the first terminal of the resetting unit, wherein the reset scan signal or the first scan signal is transmitted from the first terminal of the resetting unit to the second terminal of the resetting unit.

13. The pixel structure of claim 6, wherein the resetting unit comprises:
a first terminal configured to receive a reference voltage;
a second terminal electrically coupled to the second terminal of the transistor; and
a control terminal configured to receive a reset scan signal so as to transmit the reference voltage from the first terminal of the resetting unit to the second terminal of the resetting unit according to the reset scan signal.

14. The pixel structure of claim 6, wherein the resetting unit comprises:
a first terminal configured to receive a reset scan signal;
a second terminal electrically coupled to the second terminal of the transistor; and
a control terminal electrically coupled to the first terminal of the resetting unit, wherein the reset scan signal is transmitted from the first terminal of the resetting unit to the resetting unit the second terminal.

15. A driving method, configured to drive a pixel structure, wherein the pixel structure comprises a light-emitting diode, a data-receiving unit, a transistor, a compensating unit and a resetting unit, and the transistor comprises a first terminal, a second terminal and a control terminal, wherein the data-receiving unit is electrically coupled to the first terminal of the transistor, the compensating unit is electrically coupled to the control terminal and the second terminal of the transistor, and the resetting unit is electrically coupled to the light-emitting diode or the second terminal of the transistor, wherein the driving method comprises:
controlling the resetting unit to receive and transmit a reference voltage to the light-emitting diode for causing the light-emitting diode to be in a state of reverse bias;
controlling the compensating unit to provide a current path between the control terminal and the second terminal of the transistor for transmitting the reference voltage to the control terminal of the transistor;
controlling the data-receiving unit to receive and transmit a pixel data signal to a first terminal of the transistor; and
driving the light-emitting diode according to a voltage difference between the control terminal and the first terminal of the transistor.
